(19) United States
(12) Patent Application Publication
(10) Pub. No.: US 2010/0135363 A1
(43) Pub. Date: Jun. 3, 2010

(54) Supporting a Signal Acquisition

(76) Inventors: Zhengdi Qin, Tampere (FI); Harri Valio, Kammenniemi (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/885,714

(22) PCT Filed: Mar. 1, 2005
(86) PCT No.: PCT/IB05/00517

§ 371 Date: Aug. 30, 2007

(51) Int. Cl. H04B 1/707

(52) U.S. Cl. 375/147; 375/E01.002

(57) ABSTRACT

The invention relates to supporting an acquisition of a signal, wherein the signal comprises a sequence of complex valued samples, wherein the acquisition comprises an integration of the complex valued samples in subsequent integration intervals, and wherein the signal may be subject to a frequency drift. In order to enable an improved acquisition, a phase angle is estimated in the signal in a respective integration interval (step 504). The samples are adjusted based on the estimated phase angle in a respective integration interval (step 505). Only the adjusted samples from a plurality of integration intervals are then integrated (step 507, 508).

### CROSS REFERENCE TO RELATED APPLICATIONS

This application is the U.S. National Stage of International Application Number PCT/IB05/000517 filed on Mar. 1, 2005 which was published in English on Sep. 8, 2006 under International Publication Number WO 2006/092641.

### FIELD OF THE INVENTION

The invention relates to a method for supporting an acquisition of a signal. The invention relates equally to an integration component for supporting an acquisition of a signal, to a signal acquisition module comprising such an integration component, to an electronic device comprising such an integration component, to a communication system comprising such an electronic device, to a software code for supporting an acquisition of a signal and to a software program product storing such a software code.

### BACKGROUND OF THE INVENTION

A signal has to be acquired for example in CDMA (Code Division Multiple Access) spread spectrum communications.

For a spread spectrum communication in its basic form, a data sequence is used by a transmitting unit to modulate a sinusoidal carrier, and then the bandwidth of the resulting signal is spread to a much larger value. For spreading the bandwidth, the single-frequency carrier can be multiplied for example by a high-rate binary pseudo-random noise (PRN) code sequence comprising values of −1 and 1, which code sequence is known to a receiver. Thus, the signal that is transmitted includes a data component, a PRN component, and a sinusoidal carrier component. The term chip is used to designate the bits of the PRN code conveyed by the transmitted signal, as opposed to the bits of the data sequence.

A well known system which is based on the evaluation of such code modulated signals is GPS (Global Positioning System). In GPS, code modulated signals are transmitted by several satellites that orbit the earth and received by GPS receivers of which the current position is to be determined. Currently, each of the satellites transmits two microwave carrier signals. One of these carrier signals L1 is employed for carrying a navigation message and code signals of a standard positioning service (SPS). The L1 carrier signal is modulated by each satellite with a different C/A (Coarse Acquisition) code known at the receivers. Thus, different channels are obtained for the transmission by the different satellites. The carrier signal has a frequency of 1575.42 MHz and the C/A code, which is spreading the spectrum over a nominal bandwidth of 20.46 MHz, is repeated every 1023 chips, the epoch of the code being 1 ms. The carrier frequency of the L1 signal is further modulated with the navigation information at a bit rate of 50 bit/s. The navigation information, which constitutes a data sequence, can be evaluated for example for determining the position of the respective receiver.

A receiver receiving a code modulated signal has to have access to a synchronized replica of the employed modulation code, in order to be able to de-spread the data sequence of the signal. More specifically, a synchronization has to be performed between the received code modulated signal and an available replica code sequence. Usually, an initial synchronization called acquisition is followed by a fine synchronization called tracking. In both synchronization scenarios correlation means are used to find and maintain the best match between the replica code sequence and the received signal and thus to determine the received code phase. The match can be determined for example with chip accuracy. If an accuracy of a fraction of a chip is needed, the chip can be presented by several samples after an analog-to-digital conversion.

During the acquisition, the phase of the received code modulated signal relative to the available replica code sequence can have any possible value due to uncertainties in the position of the receiver, to uncertainties in the available time and/or to a lack of ephemeris information.

Moreover, an additional frequency modulation of the received signal may occur, which can be as large as +/−6 kHz due to a Doppler effect and several kHz due to receiver oscillator frequency uncertainty. The search of the received code phase is therefore usually performed with different assumptions on an additional frequency modulation.

For illustration, FIG. 1 presents a schematic block diagram of a signal acquisition module 10 of a conventional receiver.

The code modulated signal is received via an antenna 19 and forwarded to a radio frequency (RF) part 11. The RF part 11 converts the received signal to the base band using a local oscillator. The base band signal is then converted into the digital domain by an analog-to-digital (AD) converter 12 and enters the digital base band part of the receiver. The resulting samples are mixed by a mixer 13 with a search center frequency ej^{jωt}.

The signal output by the AD converter 12 has two unknown frequency components, a component resulting from the Doppler effect on the carrier frequency of the received signal and an oscillator error component. The mixer 13 is able to carry out several consecutive searches with different search center frequencies to compensate for such frequency components.

Optionally, the mixed samples may then be decimated by a decimation block 14 in accordance with a provided code frequency. The mixed and decimated samples are provided to a matched filter 15 to find out the code phase, or delay, of the received signal compared to an available replica code sequence. The matched filter 15 outputs continuously correlation values for each checked code phase.

The correlation values output by the matched filter 15 are integrated coherently by a coherent integration block 16.

For a high sensitivity, which is required in particular in weak signal environments like indoor environments, a receiver normally uses long integrations to achieve a sufficient signal-to-noise ratio for a reliable detection.

A long-time coherent integration, however, is prevented by the non-coherence of the signal itself, that is, by a changing phase angle of the signal. The phase angle of the signal may change due to various reasons, for instance because the oscillator frequency in the RF part 11 is drifting or because of a drift in the Doppler frequency. It is not possible, for example, to coherently integrate a signal for over one second, if there is a 1 Hz frequency drift of the oscillator. If the drifting frequency is known, it can easily be compensated. If the drifting frequency is not known but linear and thus stable, several frequency bins can be used to ‘test’ it. Unfortunately, though, the frequency drift is not predictable. Mostly, it is not even linear and stable during the required integration time. Such changes cannot be taken into account by assuming various frequency bins, since the signal does not stay in a single frequency bin. The signal energy is rather spread over several frequency bins.

To deal with this kind of problem, it is known to carry out a partial coherent integration only for a respective period of time during which the coherency of the signal is guaranteed. Subsequently, several coherent results are further combined to enhance the signal. Typically, this further combining is achieved by means of a non-coherent integration, in which only the amplitude of the signal is used. A non-coherent integration has the advantage that the phase of the signal does not have an influence onto the integration result.

In the example of FIG. 1, the coherent integration block 16 is therefore followed by a non-coherent integration block 17. The non-coherent integration block 17 integrates consecutive coherent integration results by summing the absolute or the squared values of these coherent integration results. New squared values are added for the respective duration of a non-coherent integration period.

If the assumptions on the code phase and the frequency modulation belonging to one combination are correct for the received code modulated signal, then the correlation results in a larger integration value than in the case of a misalignment or an inappropriate compensation of a frequency modulation. A peak detector 18 is thus used for detecting the correlation peak and for comparing it with a certain threshold, in order to find the correct code phase and the correct frequency of modulation.

An acquisition making use of short coherent integrations which are followed by a non-coherent integration is described for example in U.S. Pat. No. 6,606,346 B2.

The price paid for the non-coherent integration, however, is a so-called ‘squaring loss’ resulting from the loss of the phase information. The problem is getting worse for a weak signal acquisition when the signal-to-noise ratio is far below zero decibels.

It has to be noted that a similar problem may occur with any other receiver of code modulated signals, in particular with any other receiver for a Global Navigation Satellite System (GLASS).

### SUMMARY OF THE INVENTION

The invention enables an improved signal acquisition.

A method for supporting an acquisition of a signal is proposed, wherein the signal comprises a sequence of complex valued samples, wherein the acquisition comprises an integration of these complex valued samples in subsequent integration intervals, and wherein the signal may be subject to a frequency drift. The method comprises estimating at least one phase angle in the signal in a respective integration interval. The method further comprises adjusting the samples based on the at least one estimated phase angle in a respective integration interval. The method further comprises integrating adjusted samples from a plurality of integration intervals.

Moreover, an integration component for supporting an acquisition of a signal is proposed, wherein the signal comprises a sequence of complex valued samples, wherein the acquisition comprises an integration of the complex valued samples in subsequent integration intervals, and wherein the signal may be subject to a frequency drift. The integration component comprises a phase estimator adapted to estimate at least one phase angle in a signal, which is to be acquired, in a respective integration interval. The integration component further comprises a signal rotator adapted to adjust complex valued samples of a signal, which is to be acquired, based on at least one phase angle estimated by the phase estimator for a respective integration interval. The integration component further comprises an adaptive integrator adapted to integrate adjusted samples of a plurality of integration intervals provided by the signal rotator.

Moreover, a signal acquisition module is proposed, which comprises such an integration component.

Moreover, an electronic device is proposed, which comprises such an integration component.

Moreover, a communication system is proposed, which comprises such an electronic device and a network element of a communication network.

Moreover, a software code for supporting an acquisition of a signal is proposed, wherein the signal comprises a sequence of complex valued samples, wherein the acquisition comprises an integration of the complex valued samples in subsequent integration intervals, and wherein the signal may be subject to a frequency drift. When running in an electronic device, the software code realizes the steps of the proposed method.

Finally, a software program product is proposed, in which the proposed software code is stored.

The invention proceeds from the consideration that frequency drifts in a signal can be compensated at least before a final integration is performed. It is therefore proposed that, in contrast to a conventional coherent integration, a phase angle in a particular integration interval is first estimated and corrected, before a signal part in a first integration interval is combined with signal parts from other time intervals. The indication that frequency drifts are to be compensated at least before a final integration is performed means that it is possible that some integration has already been performed before the compensation. For instance, if a full length matched filter operation is used, then the signal is already coherently integrated over one full code. Further, a coherent integration for a short period, for instance 4 ms, may be performed before the phase angle correction, in order to increase the reliance of the phase estimation. But the integration part that is performed after the phase angle correction will usually be the main part of the integration.

The signal which is to be acquired according to the invention is a signal which is to be subjected to an integration. This signal can be obtained, for example, by correlating a down-converted, code modulated RF signal with an available replica code sequence in various integration intervals, for example by means of a matched filter. Thus, it is to be understood that the support of acquisition according to the invention implies as well, for example, a support of an acquisition of a received code modulated signal.

It is an advantage of the invention that it allows an efficient integration of a signal comprising a frequency drift. In enables in particular long integration times in spite of irregular phase changes. The presented approach is very robust, for instance, against frequency drifts of an oscillator which is used for down-converting an RF code modulated signal. The presented approach is equally robust against a Doppler frequency in a received code modulated signal. The presented approach works as well with a very low signal-to-noise ratio (SNR). It may be used by itself or as a complement to a conventional integration employed for a signal acquisition.

In one embodiment of the invention, the complex valued samples of a respective integration interval of the signal are first divided into groups. A phase angle is then estimated and compensated separately for each group.

In one embodiment of the invention, the estimation of a phase angle in the signal in a respective integration interval takes account of an assumed shape of the signal. When a typical CDMA signal is correlated by a matched filter with an available replica code sequence, for example, the resulting correlation values can be assumed to have a triangular shape. In this case, a middle sample close to the peak of the triangle may be considered with higher weight than the other samples when determining the phase angle.

Similarly, the SNR could be taken into account when determining the phase angle.

If the complex valued samples are divided into groups, each group may comprise as many samples as are required for covering the assumed signal shape in the integration interval, that is, as may samples as can be expected to have a significant amplitude.

In one embodiment of the invention, the adjusted samples are integrated by summing a respective real part of the adjusted samples to the respective real part of the adjusted samples in other integration intervals.

In one embodiment of the invention, the signal is first duplicated into a plurality of signals, which are shifted against each other by respectively one sample. At least one phase angle in the signal may then be estimated in a respective integration interval for each of the plurality of signals. Further, the samples may be adjusted based on the at least one estimated phase angle in a respective integration interval for each of the plurality of signals. Further, the adjusted samples of a plurality of integration intervals may be integrated for each of the plurality of signals. Finally, the integration results for the plurality of signals may be combined to a single integration result.

The invention can be implemented in hardware and/or in software. The most computation power is needed for the phase angle estimation and the signal rotation. In a hardware realization, this task can be carried out quickly by the well known Cordic (COrdinate Rotation DIgital Computer) algorithm.

The invention can be applied in various fields. It may be employed for instance in any receiver of code modulated signals, for example, though not exclusively, for a satellite positioning or Global Navigation Satellite System (GNSS) receiver, like a GPS receiver, a Galileo receiver or a Glonass receiver. It can be employed as well, for example, in an electronic device, like a mobile terminal, which comprises such a receiver.

### BRIEF DESCRIPTION OF THE FIGURES

Other objects and features of the present invention will become apparent from the following detailed description considered in conjunction with the accompanying drawings.

FIG. 1 is a schematic block diagram of a conventional signal acquisition module;

FIG. 2 is a schematic block diagram of a satellite based navigation system which can be implemented in accordance with an embodiment of the invention;

FIG. 3 is a schematic block diagram of a coherent integration block of a signal acquisition module in the system of FIG. 2;

FIG. 4 illustrates the modeled shape of a signal input to the coherent integration block of FIG. 3; and

FIG. 5 is a flow chart illustrating an operation in the coherent integration block of FIG. 3.

### DETAILED DESCRIPTION OF THE INVENTION

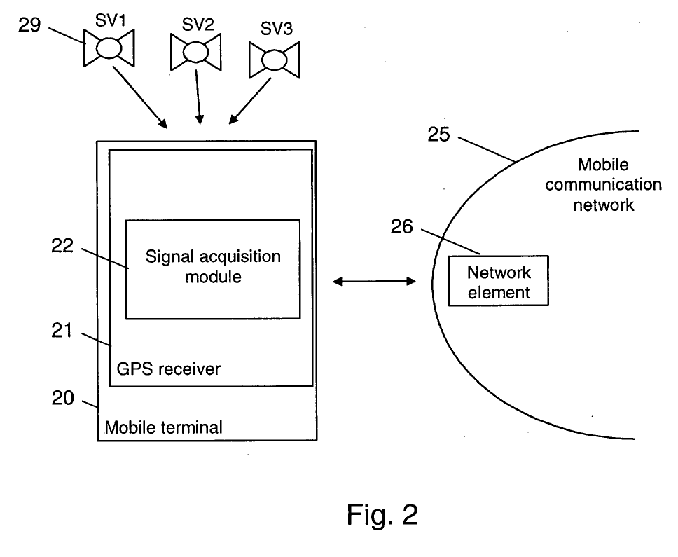

FIG. 2 is an exemplary positioning system in which a frequency drift compensation according to the invention can be implemented. The frequency drift compensation can be referred to as a ‘Shape and Phase Adaptive Integration’ or SPAI in short.

The system comprises a mobile terminal 20 of which the position is to be determined, a plurality of GPS satellites SV1-SV3 29 and a mobile communication network 25.

The mobile terminal 20 forms an embodiment of an electronic device according to the invention. It is able to communicate with the mobile communication network 25 and is implemented to this end in a conventional manner.

The mobile terminal 20 comprises in addition a GPS receiver 21, which is able to receive and process signals transmitted by GPS satellites 29. The GPS receiver 21 is constructed to this end in a conventional manner, except for a modification of a signal acquisition module 22. The mobile terminal 20 may receive assistance data from a network element 26 of the mobile communication network 25 and provide this assistance data to the GPS receiver 21 for assisting a signal acquisition.

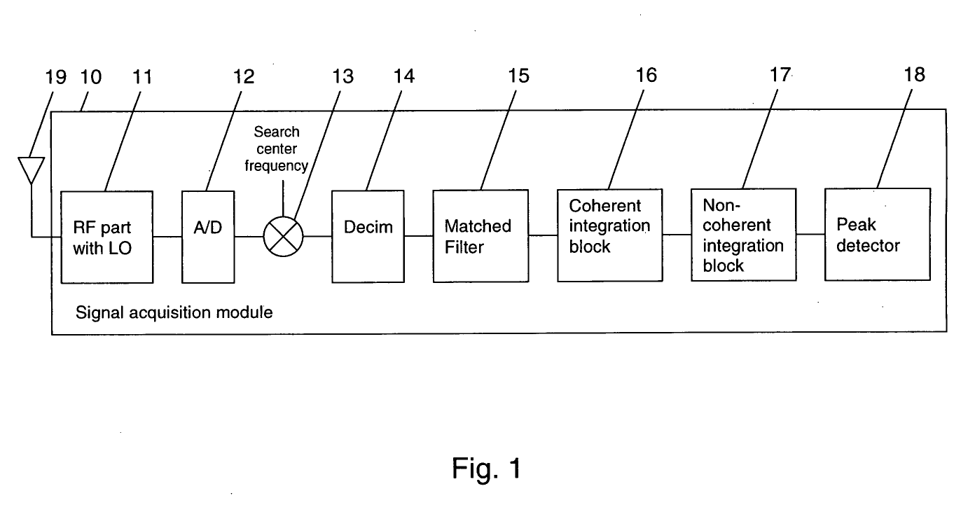

The signal acquisition module 22 corresponds to the signal acquisition module 10 presented with reference to FIG. 1, except for a SPAI block replacing the coherent integration block 16 and the non-coherent integration block 17 of the signal acquisition module 10 FIG. 1.

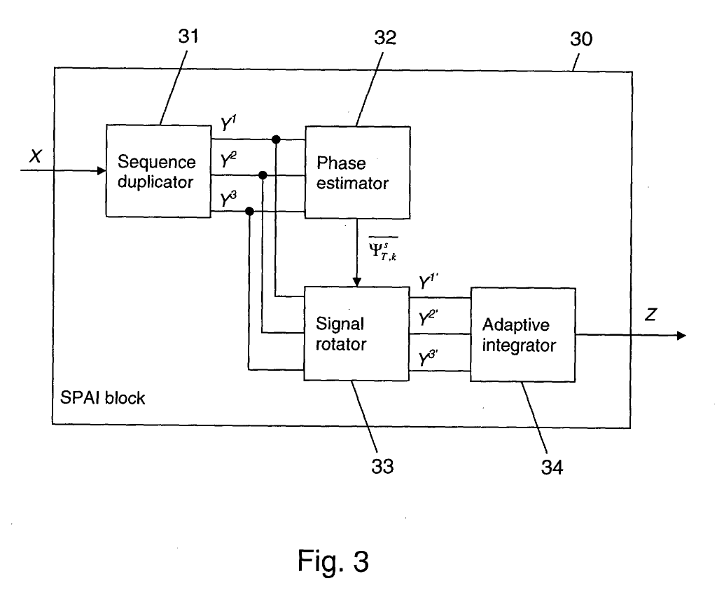

Such an SPAI block 30, forming an embodiment of an integration component according to the invention, is presented in FIG. 3.

The SPAI block 30 comprises a sequence duplicator 31, a phase estimator 32, a signal rotator 33 and an adaptive integrator 34.

The input of the sequence duplicator 31 corresponds to the input of the SPAI block 30. The output of the sequence duplicator 31 is connected on the one hand to the phase estimator 32 and on the other hand to the signal rotator 33. An output of the phase estimator 32 is equally connected to the signal rotator 33. The output of the signal rotator 33 is connected to the adaptive integrator 34. The output of the adaptive integrator 34 corresponds to the output of the SPAI block 30.

The signal acquisition module 22 of the GPS receiver 21 operates in the same manner as described with reference to the signal acquisition module 10 of FIG. 1, except for the processing in the SPAI block 30. Thus, a received code modulated signal is converted to the baseband by an RF part 11, converted into the digital domain by an A/D converter 12, mixed with selected search center frequency by a mixer 13, decimated by a decimator 14, correlated by a matched filter 15, possibly including a first coherent integration or followed by a coherent pre-integration, and integrated by the SPAI block 30. Finally, the peak in the resulting integrated correlation values is determined by a peak detector 18.

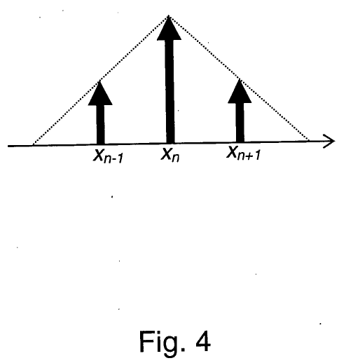

In a GPS system, the received signal can be assumed to be a typical CDMA signal. If the decimation of such a signal results in two samples per chip, the signal, or delay profile, output by the matched filter 15 has the shape of a triangle that covers three samples. FIG. 4 illustrates the amplitude of three consecutive samples xₙ₋₁, xₙ and xₙ₊₁ forming such a triangle. The acquisition task is trying to find the signal peak or peaks in the delay profile.

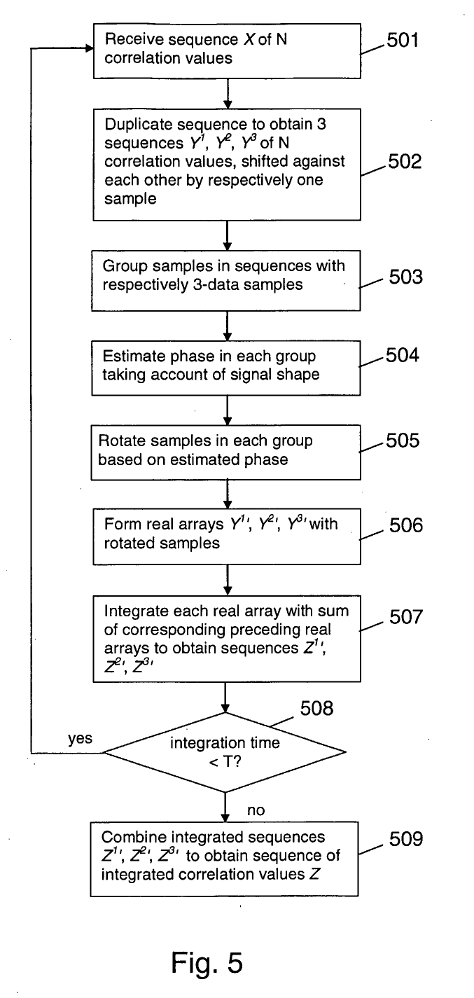

The operation in the SPAI block 30 supporting the acquisition will now be described in the following with reference to FIG. 5.

The searching range in the delay profile output by the matched filter 15 is assumed to be N complex valued samples:

X=(x₁, x₂, x₃, . . . xₙ)

This delay profile and two additional samples x_{N+1} and x_{N+2} are provided to the SPAI block 30 (step 501). Each sample corresponds to a respective correlation value, which is determined by the matched filter 15 for a particular code phase.

The sequence duplicator 31 forms three sequences Y out of the received delay profile X (step 502). To this end, the sequence duplicator 31 takes the original delay profile X as a first sequence Y¹. Further, the sequence duplicator 31 shifts the original delay profile X by one sample and uses the resulting delay profile as a second sequence Y². Further, the sequence duplicator 31 shifts the original delay profile X by two samples and uses the resulting delay profile as a second sequence Y³. The resulting sequences are thus:

$$Y = \{ \begin{matrix}{Y}^{1} = ( {x}_{1} , {x}_{2} , {x}_{3} , … , {x}_{N} ) \\ {Y}^{2} = ( {x}_{2} , {x}_{3} , {x}_{4} , … , {x}_{N + 1} ) \\ {Y}^{3} = ( {x}_{3} , {x}_{4} , {x}_{5} , … , {x}_{N + 2} )\end{matrix}$$

The sequences Y¹, Y², Y³ are then provided to the phase estimator 32 and to the signal rotator 33.

The phase estimator 32 considers respectively three consecutive samples to form a group k (step 503):

$$Y = \{ \begin{matrix}{Y}_{k}^{1} = ( \overbrace{{x}_{1} , {x}_{2} , {x}_{3} ,}^{k = 1} \overbrace{{x}_{4} , {x}_{5} , {x}_{6} ,}^{k = 2} \overbrace{{x}_{7} , {x}_{8} , {x}_{9} ,}^{k = 2} … ) \\ {Y}_{k}^{2} = ( \overbrace{{x}_{2} , {x}_{3} , {x}_{4} ,}^{k = 1} \overbrace{{x}_{5} , {x}_{6} , {x}_{7} ,}^{k = 2} \overbrace{{x}_{8} , {x}_{9} , {x}_{10} ,}^{k = 3} … ) \\ {Y}_{k}^{3} = ( \overbrace{{x}_{3} , {x}_{4} , {x}_{5} ,}^{k = 1} \overbrace{{x}_{6} , {x}_{7} , {x}_{8} ,}^{k = 2} \overbrace{{x}_{9} , {x}_{10} , {x}_{11} ,}^{k = 3} … )\end{matrix}$$

The presented frequency drift compensation is based on the consideration that the signal peak might be in the middle of any group.

Since the signal shape covers three samples, only three sequences Y are needed. If the signal shape covers more chips, more sequences are needed with a shift by one sample for each group. The number of the groups in each sequence depends on the length of the delay profile or the acquisition searching range.

The phase estimator 32 estimates the phase in each group, taking account of the assumed signal shape (step 504). The phase estimator 32 assumes for each of the 3-sample groups that the peak might be given by the middle sample xₙ of the group. In order to correct the phase of the signal before the integration with other copies of the delay profile, a phase estimation is performed for each group. The phase estimation is based on the principle of the maximum ratio combination for all the samples in the group. In the present example, the phase for group k, with k=1 to N/3, of sequence s, with s=1 to 3, at the present time period T is estimated to be:

ψ̅_̅{̅T̅,̅k̅}̅^̅{̅s̅}̅=angle[xₙ+ξ(xₙ₋₁+xₙ₊₁)]

In this equation, xₙ₋₁ represents the first sample, xₙ the second and thus middle sample, and xₙ₊₁ the last sample in the respective group k. Further, ξ is a combination factor that depends on the signal shape and the SNR. The operator angle[ ] takes the phase of the complex sum defined within the brackets.

In an alternative phase estimation, the phase is estimated for each sample, and the resulting phases are then weighted and added:

$$\overline{{ψ}_{T , k}^{s}} = \frac{angle ( {x}_{n} ) + ζ * [ angle ( {x}_{n - 1} ) + angle ( {x}_{n + 1} ) ]}{( 1 + 2 ζ )}$$

where ζ is another combination factor that depends on the signal shape and the SNR.

If the phase change is not fast, the phase estimation can be extended over several time periods T. That is, if it is known that the phase is not changing rapidly but stays the same over many input sample groups k, the same estimated phase value can be used without calculating a new one.

The phase estimator 32 provides the estimated phase ψ̅_̅{̅T̅,̅k̅}̅^̅{̅s̅}̅ for each group of each sequence Y to the signal rotator 33.

The signal rotator 33 tries to approximate the signal phase to zero in each group in the sequences Y received from the sequence duplicator 31 so that an adaptive integration can be done over different time periods T.

The signal rotator 33 performs to this end a rotation of all samples xₘ in each group k by a negative value − ψ̅_̅{̅T̅,̅k̅}̅^̅{̅s̅}̅ of the phase estimated for this group k (step 505):

x′ₘ=xₘ·exp{ ψ̅_̅{̅T̅,̅k̅}̅^̅{̅s̅}̅} {=m=n−1, n+1}

After the rotation, the signal rotator 33 arranges the real values of the rotated samples for each sequence in a respective real array (step 506):

$${Y}^{′} = \{ \begin{matrix}{Y}^{1 ′} = real ( {x}_{1}^{′} , {x}_{2}^{′} , {x}_{3}^{′} , … , {x}_{N}^{′} ) \\ {Y}^{2 ′} = real ( {x}_{2}^{′} , {x}_{3}^{′} , {x}_{4}^{′} … , {x}_{N + 1}^{′} ) \\ {Y}^{3 ′} = real ( {x}_{3}^{′} , {x}_{4}^{′} , {x}_{5}^{′} … , {x}_{N + 2}^{′} )\end{matrix}$$

These real arrays Y^{1′}, Y^{2′}, Y^{3′} are then provided by the signal rotator 33 to the adaptive integrator 34.

The adaptive integrator 34 aligns the real arrays Y^{1′}, Y^{2′}, Y^{3′} resulting for the current integration time T and adds them to summed up real arrays Y^{1′}, Y^{2′}, Y^{3′}, respectively, of preceding integration times T to obtain a better SNR (step 507):

$${Z}^{′} = \{ \begin{matrix}{Z}^{1 ′} = ( {z}_{1}^{1 ′} , {z}_{2}^{1 ′} , {z}_{3}^{1 ′} , … , {z}_{N}^{1 ′} ) \\ {Z}^{2 ′} = ( {z}_{1}^{2 ′} , {z}_{2}^{2 ′} , {z}_{3}^{2 ′} , … , {z}_{N}^{2 ′} ) \\ {Z}^{3 ′} = ( {z}_{1}^{3 ′} , {z}_{2}^{3 ′} , {z}_{3}^{3 ′} , … , {z}_{N}^{3 ′} )\end{matrix} \} = ( \begin{matrix}{\sum }_{T} {Y}_{T}^{1 ′} \\ {\sum }_{T} {Y}_{T}^{2 ′} \\ {\sum }_{T} {Y}_{T}^{3 ′}\end{matrix} )$$

The total number of integration times T can be as large as necessary. Steps 501 to 507 are repeated to this end T times (step 508).

Finally, the adaptive integrator 34 shifts the samples of the resulting sequences Z′ back to the original position. That is, sequence Z²′ is shifted back by one sample, and sequence Z³′ is shifted back by two samples. The final delay profile Z for the acquisition is then obtained by combining corresponding samples in the sequences. Shifting and combining the samples can be represented by the following equation:

$${z}_{j} = {\sum }_{s = 0}^{2} {z}_{s + j}^{s + 1 ′} ( j = 1 , 2 , 3 , … , N )$$

The resulting delay profile Z=(z₁, z₂, z₃, . . . , z_{N}) is the delay profile which is used by the peak detector 18 for the final acquisition.

Summarized, a new signal acquisition approach is introduced, in which the signal shape and the phase change in a particular time interval are first estimated and then corrected before the signal is combined with signals from other time intervals. The method is very robust against an oscillator frequency drift, especially for long integration times, as can be verified by simulations.

If there is no frequency drift, the best integration approach is a coherent integration. If the signal coherency cannot be kept during the integration, a non-coherent integration can be performed. Thus, the coherent integration is the ceiling and the non-coherent integration is the floor for an efficient integration in case of a frequency error drift. Simulations show that the presented SPAI results in an acquisition probability between the ceiling and the floor when the Doppler frequency is zero. This means that the proposed SPAI is better than the non-coherent integration but not as good as the coherent integration. If there is a small frequency drift, for example, 6 Hz Doppler against 100 ms integration time, the performance of the coherent integration deteriorates significantly, while the acquisition probability achieved with the other two approaches stays almost the same. In this case, the presented SPAI is much better than the coherent integration. The frequency drift is a big problem especially for a long-time coherent integration. The presented SPAI corrects the signal phase at each time interval and is therefore much more robust to a frequency change than a coherent integration.

Another kind of simulation may be used for evaluating the performance of the presented SPAI at different SNR levels and different integration times. It shows that SPAI can work at very low SNR and that the SPAI is convergent. This means that in order to achieve a higher acquisition probability under low SNR, the integration times can be increased without having to take care of the frequency drift.

It is to be noted that the described embodiment constitutes only one of a variety of possible embodiments of the invention. The SPAI block can be implemented by a computer readable medium embodied with software code for execution by a processor so as to implement the above described operation.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. A method comprising:
dividing a sequence of complex valued samples of a signal into groups, an acquisition of said signal comprising an integration of said complex valued samples in subsequent integration intervals, wherein said signal may be subject to a frequency drift, and wherein each group comprises as many samples as can be expected to have a significant amplitude according to an assumed signal shape in said subsequent integration intervals;
estimating a phase angle in said signal in a respective integration interval separately for each group;
adjusting said samples based on said estimated phase angles in a respective integration interval; and
integrating adjusted samples from a plurality of integration intervals.

2. The method according to claim 1, wherein said estimation of said at least one phase angle in said signal in a respective integration interval takes into account said assumed signal shape.

3. The method according to claim 2, wherein said assumed signal shape is a triangular shape.

4. The method according to claim 1, wherein said estimation of at least one phase angle in said signal in a respective integration interval takes into account a signal-to-noise ratio of said signal.

5. The method according to claim 1, wherein said adjusted samples are integrated by summing a respective real part of said adjusted samples.

6. The method according to claim 1, further comprising a preceding step of duplicating said signal into a plurality of signals shifted against each other by respectively one sample,
wherein at least one phase angle in said signal in a respective integration interval is estimated for each of said plurality of signals;
wherein said samples are adjusted based on said estimated at least one phase angle in a respective integration interval for each of said plurality of signals; and
wherein said adjusted samples of a plurality of integration intervals are integrated for each of said plurality of signals; and
wherein said integration results for said plurality of signals are combined to a single integration result.

7. An integration component comprising:
a phase estimator adapted to estimate phase angles in a signal, which is to be acquired, wherein said signal may be subject to a frequency drift, wherein said signal comprises complex valued samples, which are divided into groups, an acquisition of said signal comprising an integration of said complex valued samples in subsequent integration intervals, wherein each group comprises as many samples as can be expected to have a significant amplitude according to an assumed signal shape in said subsequent integration intervals, and wherein said phase estimator is adapted to estimate a phase angle in a respective integration interval separately for each group;
a signal rotator adapted to adjust complex valued samples of a signal, which is to be acquired, based on phase angles estimated by said phase estimator for a respective integration interval; and
an adaptive integrator adapted to integrate adjusted samples of a plurality of integration intervals provided by said signal rotator.

8. The integration component according to claim 7, wherein said phase estimator is adapted to take into account said assumed signal shape in said estimation of said phase angles in said signal in a respective integration interval.

9. The integration component according to claim 8, wherein said assumed signal shape is a triangular shape.

10. The integration component according to claim 7, wherein said phase estimator is adapted to take into account a signal-to-noise ratio of said signal in said estimation of said phase angles in said signal in a respective integration interval.

11. The integration component according to claim 7, wherein said adaptive integrator is adapted to integrate adjusted samples by summing a respective real part of said adjusted samples.

12. The integration component according to claim 7, further comprising a sequence duplicator adapted to duplicate said signal into a plurality of signals shifted against each other by respectively one sample,
wherein said phase estimator is adapted to estimate at least one phase angle in said signal in a respective integration interval for each of said plurality of signals;
wherein said signal rotator is adapted to adjust said samples based on said estimated at least one phase angle in a respective integration interval for each of said plurality of signals;
wherein said adaptive integrator is adapted to integrate said adjusted samples of a plurality of integration intervals for each of said plurality of signals; and
wherein said adaptive integrator is adapted to combine said integration results for said plurality of signals to a single integration result.

13. A signal acquisition module comprising an integration component according to claim 7.

14. An electronic device comprising an integration component according to claim 7.

15. The electronic device according to claim 14, wherein said electronic device is a satellite positioning receiver.

16. A communication system comprising an electronic device according to claim 14 and a network element of a communication network.

17. A computer readable medium embodied with software code realizing the following when running in an electronic device:
dividing a sequence of complex valued samples of a signal into groups, an acquisition of said signal comprising an integration of said complex valued samples in subsequent integration intervals, wherein said signal may be subject to a frequency drift, and wherein each group comprises as many samples as can be expected to have a significant amplitude according to an assumed signal shape in said subsequent integration intervals;
estimating a phase angle in said signal in a respective integration interval separately for each group;
adjusting said samples based on said estimated phase angles in a respective integration interval; and
integrating adjusted samples of a plurality of integration intervals.

18. The computer readable medium according to claim 17, wherein said estimation of said at least one phase angle in said signal in a respective integration interval takes into account an assumed shape of said signal.

19. The computer readable medium according to claim 18, wherein said assumed shape of said signal is a triangular shape.

20. The computer readable medium according to claim 17, wherein said estimation of at least one phase angle in said signal in a respective integration interval takes into account a signal-to-noise ratio of said signal.

21. The computer readable medium according to claim 17, wherein said adjusted samples are integrated by summing a respective real part of said adjusted samples.

22. The computer readable medium according to claim 17, further realizing a duplicating of said signal into a plurality of signals shifted against each other by respectively one sample,
wherein at least one phase angle in said signal in a respective integration interval is estimated for each of said plurality of signals;
wherein said samples are adjusted based on said estimated at least one phase angle in a respective integration interval for each of said plurality of signals; and
wherein said adjusted samples of a plurality of integration intervals are integrated for each of said plurality of signals; and
wherein said integration results for said plurality of signals are combined to a single integration result.

23. (canceled)
